(19) United States
(12) Patent Application Publication
(10) Pub. No.: US 2015/0188486 A1
(43) Pub. Date: Jul. 2, 2015

(54) ALTERNATING CURRENT PHOTOVOLTAIC MODULE

(71) Applicant: Marco A. Marroquin, Austin, TX (US)

(72) Inventor: Marco A. Marroquin, Austin, TX (US)

(21) Appl. No.: 14/585,975

(22) Filed: Dec. 30, 2014

Related U.S. Application Data
(60) Provisional application No. 61/922,146, filed on Dec. 31, 2013.

(51) Int. Cl. H02S 40/32

(52) U.S. Cl. CPC H02S 40/32

(57) ABSTRACT

Various technologies for integrating an inverter with a photovoltaic module are disclosed.

This application claims priority under 35 U.S.C. §119 to U.S. Patent App. Ser. No. 61/922,146, which was filed on Dec. 31, 2013 and is expressly incorporated herein by reference.

### GOVERNMENT RIGHTS

This invention was made in part with government support under Grant No. DE-EE0005341 awarded by the Department of Energy. The Government has certain rights in this invention.

### TECHNICAL BACKGROUND

The present disclosure relates, generally, to photovoltaic (PV) modules and, more particularly, to photovoltaic modules having a power inverter integrated therewith for converting direct current (DC) power generated by the PV module to alternating current (AC) power.

### BACKGROUND

A typical DC PV module generally includes a rectangular frame (typically aluminum), a PV laminate, and a junction (j-) box. Standard (silicon) PV modules typically have 60 or 72 solar cells, arranged electrically in a three or four series-connected “substrings.” Each substring will typically have an equal number of cells (e.g., 20 cells for a 60-cell module) and have a bypass diode placed in parallel with the series cells.

A typical j-box has a plastic housing containing those bypass diodes, which are often mounted on a small printed circuit board, and two PV wires (a positive and negative) to carry DC power from the module. The PV wires or cables are typically of the double-insulated type and have rugged connectors, commonly known as “MC-4” connectors. The PV wires carry the DC power from the module to an external circuit.

The PV module typically has “tabs” or “ribbon connectors” protruding from the backsheet of the laminate, which are used to connect the module to the diodes, printed circuit board (PCB), and PV wires. These tabs are typically placed near one edge of the module, along the center of the frame on that edge, and the j-box is normally glued to the laminate backsheet proximate to these tabs. This may aid the installer of the module as he/she places the module on a rack, he/she can easily reach under the module and grab the wires and make connections to adjacent modules.

In particular applications, the DC power generated by a DC PV module may be converted to AC power through the use of a DC-to-AC power inverter. The power inverter may be electrically coupled to the DC output of the PV module (i.e., the PV cables). The power inverter may be located physically apart from the PV module, with only the intervening wiring and associated hardware physically coupling the PV module to the power inverter.

### SUMMARY OF THE DISCLOSURE

According to one aspect of the disclosure, an inverter for a photovoltaic module is disclosed. The inverter includes a housing having a first surface configured to confront the photovoltaic module and a second surface opposite the first surface, and a plurality of terminals coupled to the housing. Each terminal is configured to connect with a direct current (DC) output of the photovoltaic module. The inverter also includes an alternating current (AC) connector positioned in an aperture defined in the second surface, a circuit board positioned between the plurality of terminals and the AC connector that is configured to convert DC power to AC power, and an access door configured to cover an opening defined in the second surface. The access door is moveable between a first position in which the plurality of terminals are accessible through the opening and a second position in which access to the plurality of terminals is prevented.

In some embodiments, the access door may be removable from the housing to permit access to the plurality of terminals. The second surface of the housing may have a plurality of fins formed thereon.

In some embodiments, the inverter may also include a plurality of diodes, and each diode may be associated with a corresponding terminal of the plurality of terminals.

In some embodiments, the aperture may define a cross. The AC connector may include a first set of pins positioned in a first orientation, a second set of pins positioned in a second orientation different from the first orientation, and each of the first set of pins and the second set of pins may provide a complete electrical connection such that the second set of pins is redundant to the first set of pins.

In some embodiments, the second orientation may be positioned orthogonal to the first orientation.

According to another aspect, an alternating current photovoltaic (ACPV) module is disclosed. The ACPV includes a photovoltaic module having a direct current (DC) output, and an inverter positioned over the DC output connector. The inverter includes a housing secured to the photovoltaic module, a DC input connector connected to the DC output connector, an alternating current (AC) connector, a circuit board positioned between the DC input connector and the AC connector that is configured to convert DC power to AC power, and an access door configured to cover an opening defined in the outer surface of the housing. The access door is moveable between a first position in which the DC input connector and the DC output connector are accessible through the opening and a second position in which access to the DC input connector and the DC output connector is prevented.

In some embodiments, the DC output connector of the photovoltaic module may include a plurality of pins extending from a back surface thereof.

In some embodiments, the DC input connector may include a plurality of spring clips.

In some embodiments, the access door may be removable from the housing to permit access to the DC input connector and the DC output connector.

In some embodiments, the inverter may further include a plurality of diodes.

In some embodiments, the outer surface of the housing may have a plurality of fins formed thereon.

Additionally, in some embodiments, the photovoltaic module may include a support frame, and the housing of the inverter may be secured to the support frame via a mechanical fastener. In some embodiments, the alternating current (AC) connector may be positioned in an aperture defined in an outer surface of the housing

According to another aspect, an inverter for a photovoltaic module may include a housing having a first surface configured to confront the photovoltaic module, a second surface opposite the first surface, and a connection chamber positioned between the first surface and the second surface. A plurality of electrical terminals may be positioned in the connection chamber, and each terminal may be configured to connect with a direct current (DC) output terminal of the photovoltaic module. A plurality of alternating current (AC) terminals may be positioned in an aperture defined in the second surface of the housing. A circuit board positioned between the plurality of pins and the AC connector may be configured to convert DC power to AC power. The inverter may also include an access door configured to cover the connection chamber. The access door may be moveable between a first position in which the plurality of electrical terminals are accessible and a second position in which access to the plurality of electrical terminals is prevented.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified illustration of an ACPV module including an inverter;

FIG. 2 is a perspective view of another illustration of the ACPV module of FIG. 1;

FIG. 3 is a rear perspective view of the inverter of the ACPV module of FIGS. 1-2;

FIG. 4 is a perspective view of a connector of an AC cable configured to connect with the inverter of FIGS. 1-3;

FIG. 5 is a plan view of the connector of FIG. 4;

FIG. 6 is a simplified illustration of the ACPV module of FIG. 1 with the inverter and AC cable in one orientation;

FIG. 7 is a view similar to FIG. 6 with the inverter and AC cable in another orientation;

FIG. 8 is a simplified illustration of a number of ACPV modules with inverters and an AC cable in the orientation of FIG. 6;

FIG. 9 is another simplified illustration of a number of ACPV modules with inverters and an AC cable in the orientation of FIG. 7;

FIG. 10 is a perspective view of another embodiment of an inverter;

FIG. 11 is an exploded perspective view of the inverter of FIG. 10;

FIG. 12 is a cross-sectional elevation view of the inverter of FIGS. 10-11;

FIG. 13 is a simplified illustrative of one ACPV module including the inverter of FIG. 10 and a trunk cable; and

FIG. 14 is a simplified illustration of an alternating current cable and an ACPV module including another embodiment of an inverter.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

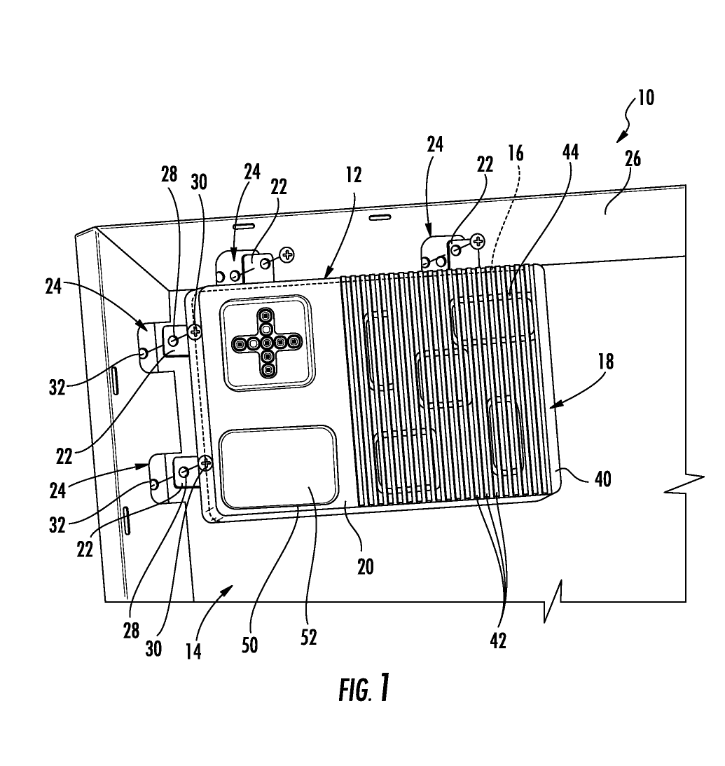

Referring now to FIGS. 1-14, the present disclosure relates to various embodiments of ACPV modules in which a DC-AC inverter, commonly referred to as a “microinverter,” is attached to the PV module in different configurations to form the ACPV module. In some typical ACPV module implementations, the junction box of the PV module is replaced with the microinverter. In such implementations, the junction box may be expanded to include the hardware for the microinverter such that the microinverter and the typical junction box wiring and connectors share the same housing. The expanded box is positioned near one edge of the module and centered along that edge. Typically, it would be glued to the PV module backsheet and/or coupled to the nearby frame via a bracket. Compared to a standard j-box, however, the microinverter is relatively heavy and complex compared to the simple circuit board typically included in a standard junction box, which provides wire connections and bypass diodes. The weight of a typical microinverter can make it difficult to maintain adhesion or a reliable bond to the backsheet. The weight of the typical microinverter also can cause the PV module to delaminate, resulting in a module failure. Additionally, the repair of the microinverter or module itself is generally more difficult. For example, if an ACPV module microinverter fails, it may be difficult or impossible to replace just the microinverter, causing the loss of both the microinverter and the PV module. Further, grounding of the microinverter and PV module may pose another challenge.

The output leads or cables from the microinverter carry AC power rather than the DC power generated by the PV module. Typically, the AC cables are configured to connect adjacent modules electrically in parallel and are assembled in a cable jacked with a connector. These wires are often connected in what looks like a daisy chain fashion normally used for DC wires, but in fact the connections are in parallel, rather than series. Since normally three or four AC wires are needed (e.g., line-1, line-2, ground, and neutral, depending on the target market), the cable assembly can be relatively expensive and unwieldy.

One embodiment that has been implemented to address the challenges of a typical ACPV module is illustrated in FIGS. 1-9. As shown in FIG. 1, an ACPV module 10 includes a microinverter 12 secured to a PV module 14. The microinverter 12 includes a circuit board 16 that is configured to convert DC power to AC power and is encased within an outer housing 18. The outer housing 18 includes a main body 20 and a number of flanges 22 that extend outwardly from the main body 20. Each flange 22 is sized to be positioned in a slot 24 defined in the frame 26 of the PV module 14. In the illustrative embodiment, each flange 22 has a mounting hole 28 sized to receive a fastener such as, for example, screw 30, which may be threaded into a bore 32 defined in the frame 26. In that way, the microinverter 12 may be secured to the PV module 14.

In this approach, the slots 24 facilitate flush screw connections. In past frame attachments, a need existed for different mechanical designs to mate with the different types of frames made by various manufacturers. The slots 24 permit the entire microinverter 12 to be “flush” with the frame 26 of the module 14 without features that protrude from the plane of the frame 26. It should be appreciated that holes defined in the frame and microinverter can both be threaded to avoid hardware (such as nuts). It should be appreciated that in other embodiments the outer housing 18 and/or the frame 26 may include other tabs, flanges, slots, or other mechanical fastening devices to secure the microinverter 12 to the PV module 14. In still other embodiments, the microinverter may be attached using an adhesive such as glue.

The outer housing 18 of the microinverter 12 is illustratively formed from a polymeric material such as, for example, molded plastic. The housing 18 has an outer surface 40 that faces away from the PV module 14 when the housing 18 is attached thereto. As shown in FIG. 1, the outer surface 40 has a number of fins 42 defined therein that act as heat sinks for the microinverter 12. It should be appreciated that in other embodiments the housing 18 may include additional heat sinks for the microinverter 12, and, in yet other embodiments, the heat sinks may be omitted.

In the illustrative embodiment, the housing 18 includes an inverse skyline 44 that follows the overall surface of the internal electrical components, including, for example, the circuit board 16. The skyline 44 minimizes the empty space within the housing 18 and potentially saves on cost by reducing the amount of encapsulation material (such as potting) that may be required. The skyline feature 44 may be hollow or filled with more fins such that heat removal may be further aided.

The housing 18 may also include a number of features such as, for example, internal standoffs. Additionally, the circuit board 16 may be oriented such that the “tall” components of the board 16 are protruding away from the backsheet (such that when the module 10 is installed, the components point toward the roof).

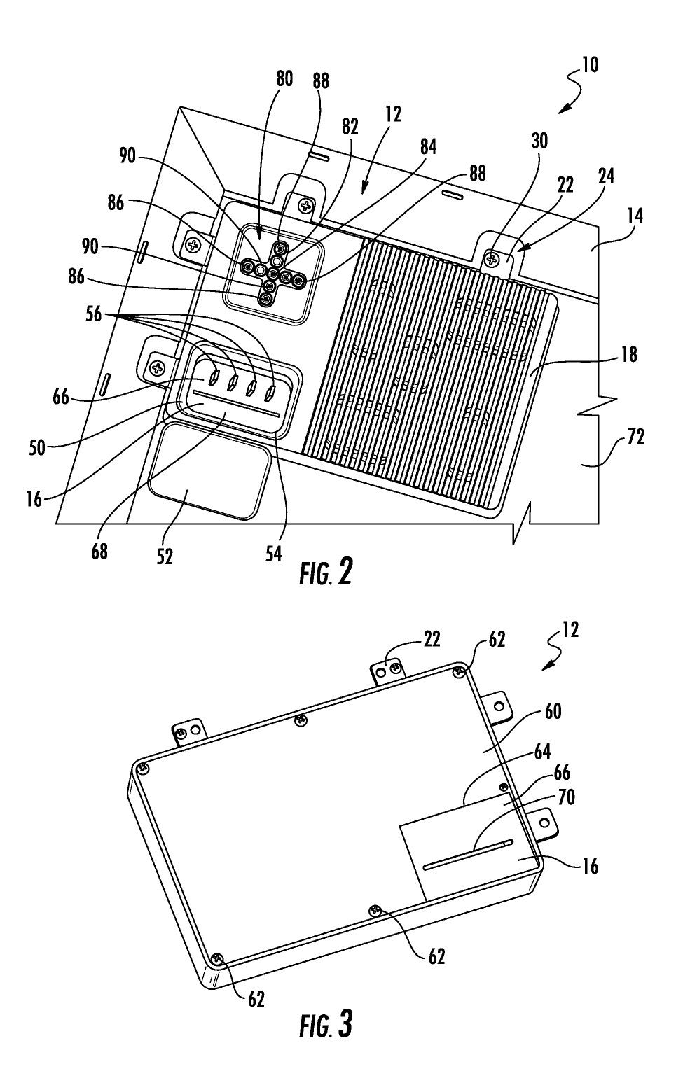

As shown in FIGS. 1-2, an access opening 50 is defined in the outer surface 40 of the housing 18, and the microinverter 12 includes a panel 52 that is configured to cover the opening 50. As shown in FIG. 2, a chamber 54 is defined below the opening 50, which is accessible when the panel 52 is removed. The microinverter 12 includes a plurality of terminals 56 that are positioned in the chamber 54 and accessible through the opening 50. Each terminal 56 is coupled to the circuit board 16 and is configured to connect with a DC output (not shown) of the PV module 14. In the illustrative embodiment, the microinverter 12 includes four terminals 56, but this number may vary depending on designer preferences and the configuration of the PV module.

The panel 52 acts as an access door that selectively permits and prevents access to the connection chamber 54. In the illustrative embodiment, the panel 52 may be completely detached from the housing 18. It should be appreciated that in other embodiments the panel 52 may be attached to the housing 18 via a hinge or other fastening device. The panel 52 also include a seal (not shown) that seals the opening 50 when the panel 52 is attached to the housing 18. The seal may be an o-ring, gasket, or other features that prevents environmental ingress. The panel 52 may also include a Gore-type pressure equalization vent to address the ingress of moisture.

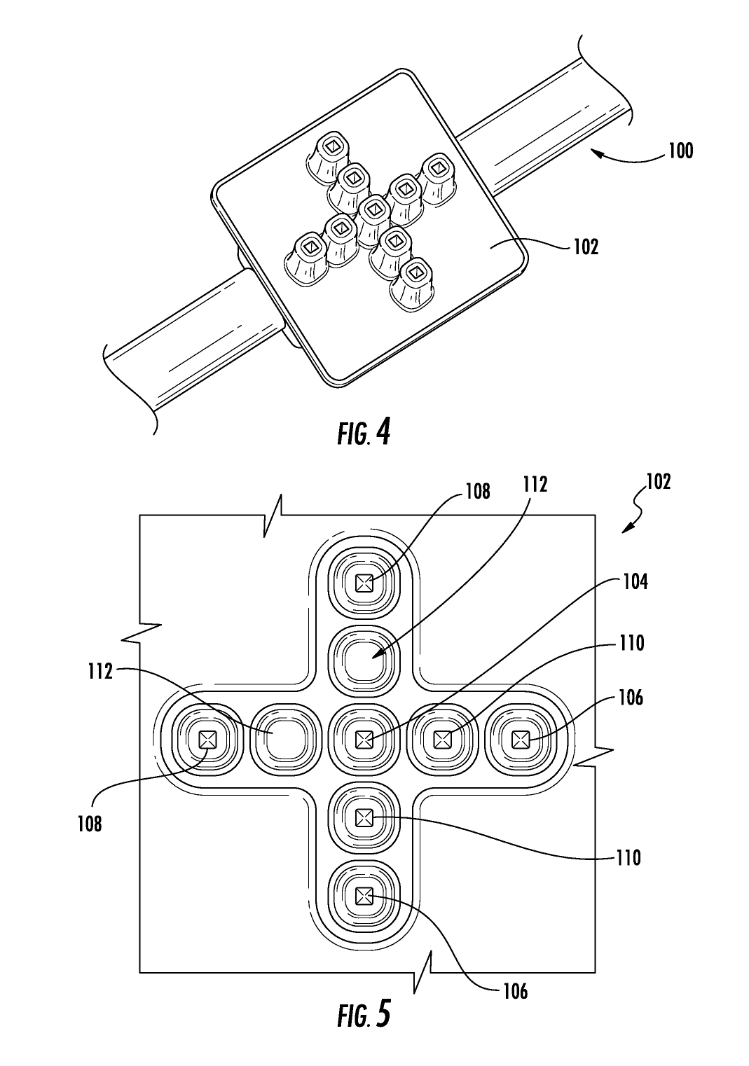

As shown in FIG. 3, the housing 18 includes a bottom panel 60 that is secured to the main body 20 via a number of screws 62. The panel 60 includes an opening 64 that is positioned below the access opening 50. The circuit board 16 includes a section 66 that defines the bottom end 68 of the chamber 54, and the section 66 has a slot 70 defined therein that is sized to receive the DC output of the PV module 14. The section 66 may also include the terminals 56 of the microinverter 12. The DC output may take the form of tabs or ribbon connectors protruding from the backsheet 72 of the PV module 14. Because the tabs of a typical PV module 14 are positioned at the center of the module, the tabs from the module must be moved to the corner in order to facilitate DC connections.

Each of the DC output tabs accesses a connection point inside the laminate of the PV module 14. In the case of a 60-cell module, all 60 cells are in series, but there are taps at each end of the string as well as taps at the 20- and 40-cell connection points as well for a total of four connections. By bringing all four points into the microinverter 12, the bypass diodes (or their equivalent function) can be managed inside the microinverter 12, thus offsetting some cost of the module. The DC output tabs of the PV module 14 can be bonded (normally with solder, but perhaps with electrical spring clips or other means) to the respective terminals 56 on the section 66 of the circuit board 16. Once this is done, the chamber 54 can be sealed with potting or coating as desired and then the panel 52 closed and, if necessary, sealed shut.

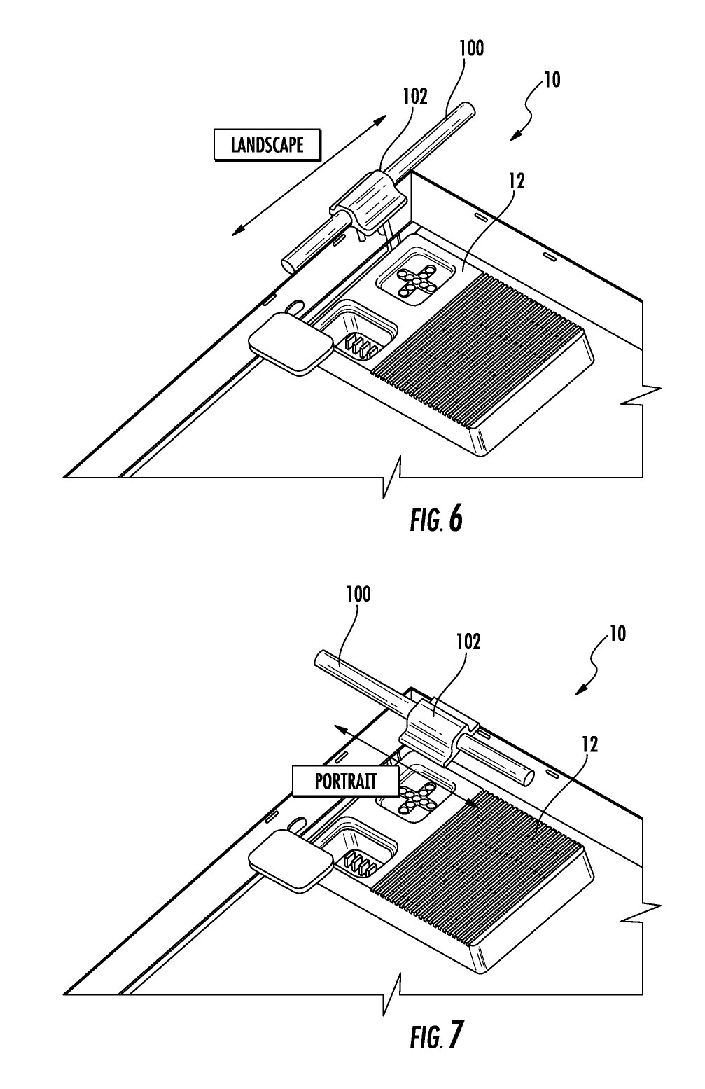

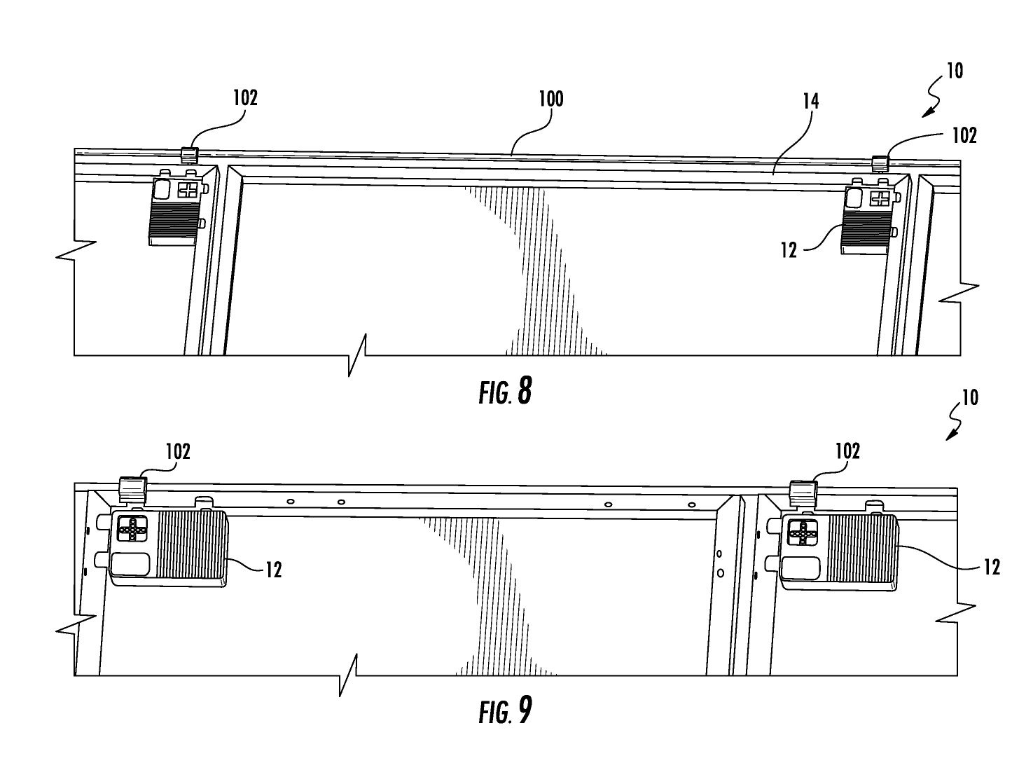

Returning to FIG. 2, the microinverter 12 also includes an AC connector 80 that is secured to the housing 18. In the illustrative embodiment, the AC connector 80 is positioned in an aperture 82 defined in the outer surface 40 of the housing 18. The aperture 82 (and hence the connector 80) has the form of a cross, “plus” sign, or “X,” which facilitates the attachment of the trunk cable 100 in both a landscape (see FIGS. 6 and 8) orientation of the PV module 14 and portrait (see FIGS. 7 and 9) orientation. In the illustrative embodiment, the AC connector 80 of the microinverter 12 is a socket that includes a single ground terminal 84 (center), a pair of line-1 terminals 86, a pair of line 2 terminals 88, and a pair of neutral terminals 90.

Correspondingly, the trunk cable 100 includes a plug 102 that has a single ground pin 104 (center), a pair of line-1 pins 106, a pair of line-2 pins 108, and a pair of neutral pins 110, as shown in FIGS. 4-5. Of the nine total slots in the plug 102, only seven are filled with electrical pins. The extra two slots 112 are vacant and pair with an unpinned plug depending on which orientation (portrait or landscape) is chosen. Additionally, in the illustrative embodiment, the plug 102 and socket connector 80 have guard pins such that the plug can be only be plugged in one way. By using a trunk cable 100, the overhead of a “drop connection” is eliminated and other complexities associated with cable entrance/exit points are minimized.

As described above, the circuit board 16 is encased within the housing 18. While the circuit board 16 includes a section 66 that is positioned in the connection chamber 54, the remainder of the board 16 is sealed within the housing 18. In that way, the other electrical components, including bypass diodes (not shown) are insulated from the operational environment of module 10. Those electrical components receive DC power from the terminals 56, convert that power to AC power, and supply the AC power to the AC connector 80.

In the illustrative embodiment, the microinverter 12 may be assembled separately from the PV module 14. Integration of the two may be accomplished by attaching the microinverter 12 (with open panel 52) to the PV module 14. The DC output tabs of the PV module 14 can be bonded (normally with solder, but perhaps with electrical spring clips or other means) to the respective terminals 56. Once this is done, the chamber 54 can be sealed with potting or coating as desired and then the panel 52 closed and, if necessary, sealed shut.

As shown in FIGS. 6-9, the microinverter 12 supports both “portrait” and “landscape” installation of the PV modules 14. That is, sometimes installers prefer to orient the modules so that their long edges are adjacent (portrait, FIGS. 7 and 9) and sometimes they prefer to place the short edges in adjacency (landscape, FIGS. 6 and 8) When the microinverter is centered on the short edge, it naturally aids portrait installations but makes landscape installations problematic, and vice versa. In the embodiment shown in FIGS. 1-9, the microinverter 12 is positioned in the corner, thereby naturally aiding in both portrait and landscape installations. As shown in FIGS. 6-9, the trunk cable 100 includes multiple plugs 102 configured to mate with the connectors 80 of a number of modules 10 to form a string of modules 10.

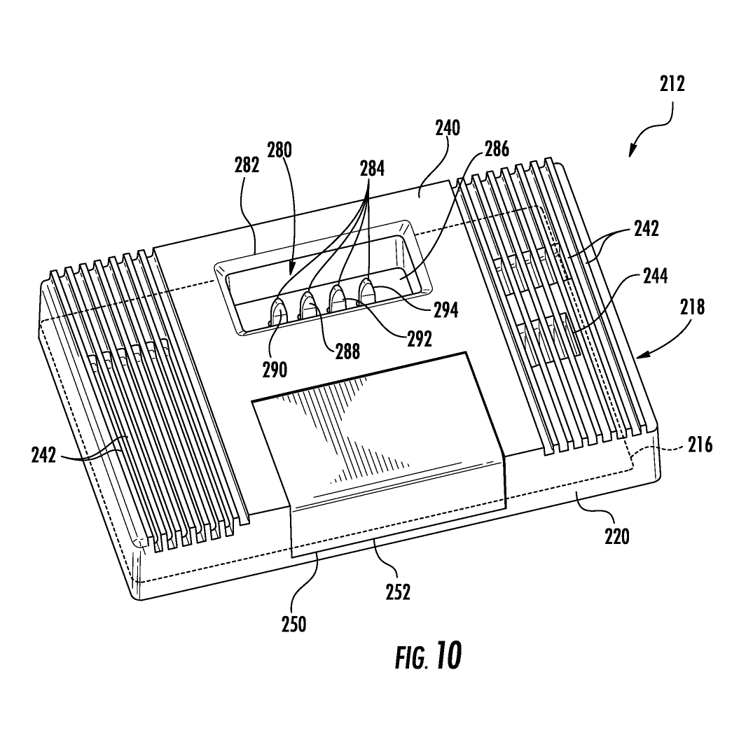

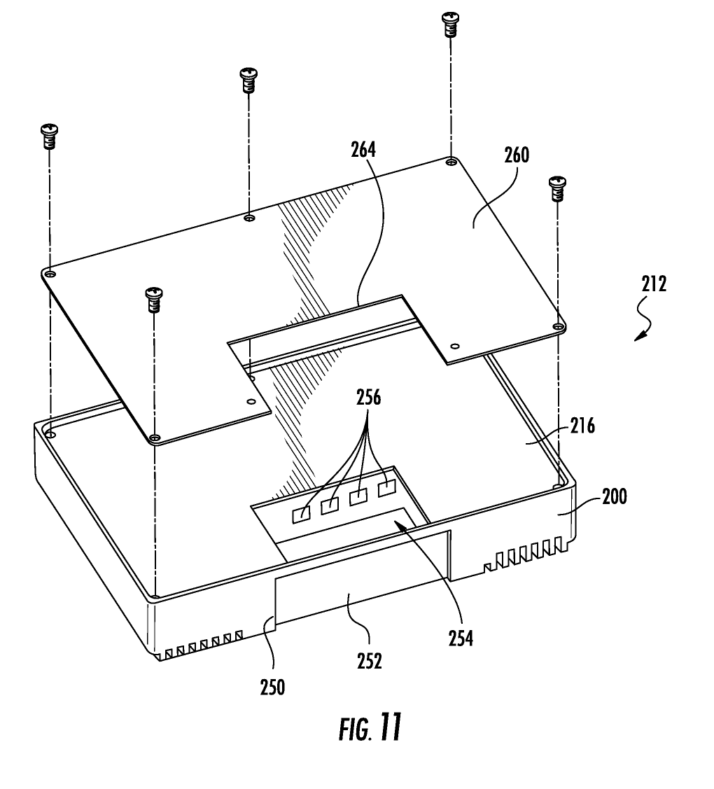

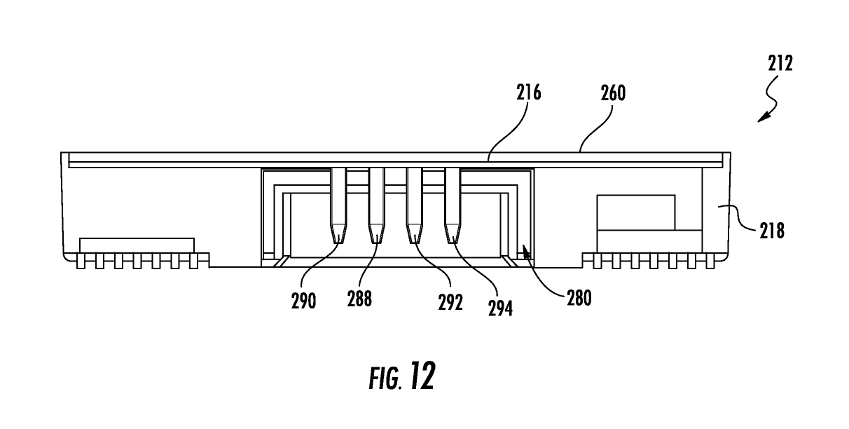

Referring now to FIGS. 10-13, another embodiment of a microinverter (hereinafter microinverter 212) is shown. In this embodiment, the microinverter 212 may be secured to a PV module 214 via an adhesive such as, for example, glue. The microinverter 212 includes a circuit board 216 that is configured to convert DC power to AC power and is encased within an outer housing 218. The outer housing 218 is illustratively formed from a polymeric material such as, for example, molded plastic. The housing 218 has an outer surface 240 that faces away from the PV module when the housing 218 is attached thereto. As shown in FIG. 10, the outer surface 240 has a number of fins 242 defined therein that act as heat sinks for the microinverter 212. It should be appreciated that in other embodiments the housing 218 may include additional heat sinks for the microinverter 212, and, in yet other embodiments, the heat sinks may be omitted.

In the illustrative embodiment, the housing 218 includes an inverse skyline 244 that follows the overall surface of the internal electrical components, including, for example, the circuit board 216. The skyline 244 minimizes the empty space within the housing 218 and potentially saves on cost by reducing the amount of encapsulation material (such as potting) that may be required. The skyline feature 244 may be hollow or filled with more fins such that heat removal may be further aided.

As shown in FIGS. 10-11, an access opening 250 is defined in the outer surface 240 of the housing 18, and the microinverter 212 includes a panel 252 that is configured to cover the opening 250. As shown in FIG. 11, a chamber 254 is defined below the opening 250, which is accessible when the panel 252 is removed. The microinverter 212 includes a plurality of terminals 256 that are positioned in the chamber 254 and accessible through the opening 250. Each terminal 256 is configured to connect with a DC output (not shown) of the PV module. In the illustrative embodiment, the microinverter 212 includes four terminals 256, but this number may vary depending on designer preferences and the configuration of the PV module.

The panel 252 acts as an access door that selectively permits and prevents access to the connection chamber 254. In the illustrative embodiment, the panel 252 may be completely detached from the housing 218. It should be appreciated that in other embodiments the panel 252 may be attached to the housing 218 via a hinge or other fastening device. The panel 252 also include a seal (not shown) that seals the opening 250 when the panel 252 is attached to the housing 218.

As shown in FIG. 11, the housing 218 includes a bottom panel 260 that is secured to the main body 220 of the housing 218. The panel 260 includes an opening 264 that is positioned below the access opening 250. The DC output may take the form of tabs or ribbon connectors protruding from the backsheet of the PV module. Each of the DC output tabs accesses a connection point inside the laminate of the PV module and extends through the opening 264 into the chamber 254 of the housing 218. The DC output tabs can be bonded (normally with solder, but perhaps with electrical spring clips or other means) to the respective terminals 256. Once this is done, the chamber 254 can be sealed with potting or coating as desired and then the panel 252 closed and, if necessary, sealed shut.

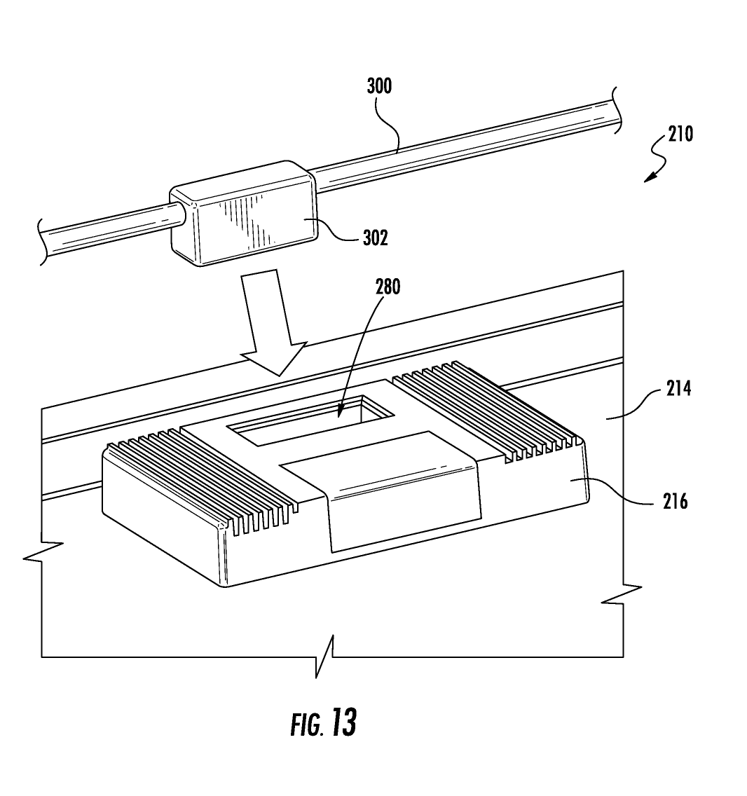

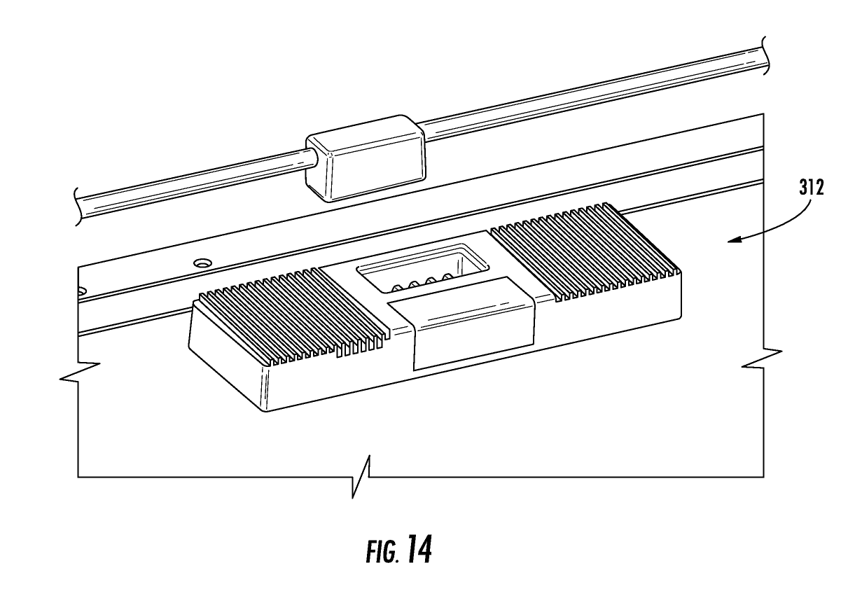

As shown in FIGS. 10 and 12, the microinverter 212 also includes an AC connector 280 that is secured to the housing 218. In the illustrative embodiment, the AC connector 280 is positioned in an aperture 282 defined in the outer surface 240 of the housing 218. The connector 280 includes a number of pins 284 that extend from a section 286 of the board 216, including a single ground 288, a line-1 pin 290, a line-2 pin 292, and a neutral terminal 294. As shown in FIG. 13, the AC connector 280 may be mated with a corresponding connector 302 of a trunk cable 300 when the microinverter 212 is secured to a PV module 214. The trunk cable 300 includes multiple plugs 302 configured to mate with the connectors 280 of a number of modules 210 to form a string of modules 210.

As described above, the circuit board 216 is encased within the housing 218. While the circuit board 216 includes a section 286 that is positioned in the aperture 282, the remainder of the board 216 is sealed within the housing 218. In that way, the other electrical components, including bypass diodes (not shown) are insulated from the operational environment of module 210. Those electrical components receive the DC power from the terminals 256, convert that power to AC power, and supply the AC power to the AC connector 280.

As shown in FIG. 14, another embodiment of a microinverter (hereinafter microinverter 312) may be more rectangular than the embodiments of FIGS. 1-13. The microinverter 312 includes additional fins positioned on each side of AC connector.

Various technologies for integrating a microinverter with a PV module have been illustrated in the Figures and described above. Although particular features have been shown and described with regard to particular embodiments, it should be appreciated that features of various embodiments may be mixed and matched as each implementation may require. For example, in some embodiments, a “standardized” microinverter may be desired for use with a variety of PV modules (which may vary in frame size and/or placement of electrical connections/junction box). Additionally, it may be desirable to uniformly locate features of the PV module across different PV modules for ease of manufacturability or certification. In such embodiments, features of the various disclosed embodiments may be selected to adapt the microinverter to each PV module as desired.

1. An inverter for a photovoltaic module, comprising:
a housing having a first surface configured to confront the photovoltaic module and a second surface opposite the first surface,
a plurality of terminals coupled to the housing, each terminal being configured to connect with a direct current (DC) output of the photovoltaic module,
an alternating current (AC) connector positioned in an aperture defined in the second surface,
a circuit board positioned between the plurality of terminals and the AC connector, the circuit board being configured to convert DC power to AC power, and
an access door configured to cover an opening defined in the second surface, wherein the access door is moveable between a first position in which the plurality of terminals are accessible through the opening and a second position in which access to the plurality of terminals is prevented.

2. The inverter of claim 1, wherein the access door is removable from the housing to permit access to the plurality of terminals.

3. The inverter of claim 1, further comprising a plurality of diodes, each diode being associated with a corresponding terminal of the plurality of terminals.

4. The inverter of claim 1, wherein the second surface of the housing has a plurality of fins formed thereon.

5. The inverter of claim 1, wherein the aperture defines a cross.

6. The inverter of claim 1, wherein the AC connector includes:
a first set of pins positioned in a first orientation,
a second set of pins positioned in a second orientation different from the first orientation, and
each of the first set of pins and the second set of pins provide a complete electrical connection such that the second set of pins is redundant to the first set of pins.

7. The inverter of claim 6, wherein the second orientation is positioned orthogonal to the first orientation.

8. An alternating current photovoltaic (ACPV) module comprising:
a photovoltaic module having a direct current (DC) output connector, and
an inverter positioned over the DC output connector, the inverter including (i) a housing secured to the photovoltaic module, (ii) a DC input connector connected to the DC output connector, (iii) an alternating current (AC) connector, (iv) a circuit board positioned between the DC input connector and the AC connector, the circuit board being configured to convert DC power to AC power, and (v) an access door configured to cover an opening defined in the housing, wherein the access door is moveable between a first position in which the DC input connector and the DC output connector are accessible through the opening and a second position in which access to the DC input connector and the DC output connector is prevented.

9. The ACPV of claim 8, wherein the DC output connector of the photovoltaic module includes a plurality of pins extending from a back surface thereof.

10. The ACPV of claim 9, wherein the DC input connector includes a plurality of spring clips.

11. The ACPV of claim 8, wherein the access door is removable from the housing to permit access to the DC input connector and the DC output connector.

12. The ACPV of claim 8, wherein the inverter further includes a plurality of diodes.

13. The ACPV of claim 8, wherein the housing has a plurality of fins formed thereon.

14. The ACPV of claim 8, wherein the aperture defines a cross.

15. The ACPV of claim 8, wherein:
the photovoltaic module includes a support frame, and
the housing of the inverter is secured to the support frame via a mechanical fastener.

16. The ACPV of claim 8, wherein the alternating current (AC) connector is positioned in an aperture defined in an outer surface of the housing.

17. An inverter for a photovoltaic module, comprising:
a housing having (i) a first surface configured to confront the photovoltaic module, (ii) a second surface opposite the first surface, and (iii) a connection chamber positioned between the first surface and the second surface
a plurality of electrical terminals positioned in the connection chamber, each terminal being configured to connect with a direct current (DC) output terminal of the photovoltaic module,
a plurality of alternating current (AC) terminals positioned in an aperture defined in the second surface of the housing,
a circuit board configured to convert DC power to AC power, and
an access door configured to cover the connection chamber, wherein the access door is moveable between a first position in which the plurality of electrical terminals are accessible and a second position in which access to the plurality of electrical terminals is prevented.
